(19) United States
(12) Patent Application Publication
(10) Pub. No.: US 2006/0145024 A1
(43) Pub. Date: Jul. 6, 2006

(54) Service vehicle for performing in-space operations on a target spacecraft, servicing system and method for using a service vehicle

(75) Inventor: Charalampos Kosmas, Ilioupolis (GR)

Correspondence Address: DAVIDSON, DAVIDSON & KAPPEL, LLC, 485 SEVENTH AVENUE, 14TH FLOOR, NEW YORK, NY, 10018, US

(73) Assignee: Intersecure Logic Limited, Nicosia (CY)

(21) Appl. No.: 10/539,489

(22) PCT Filed: Dec. 18, 2003
(86) PCT No.: PCT/EP03/14579

§ 371 Date: Nov. 25, 2005

(30) Foreign Application Priority Data
Dec. 18, 2002 (DE) 102 59 638.7

(51) Int. Cl. B64G 1/64

(52) U.S. Cl. 244/172.5

(57) ABSTRACT

A service vehicle for performing an in-space operation on a selected target spacecraft incldues a communication module having at least one of a transmission and a receiving characteristic configurable in order to meet at least one of a transmission and a receiving parameter of the selected targeted spacecraft. In addition, a servicing system using the service vehicle and a method for in-space servicing are also disclosed.

The invention relates to a service vehicle for performing in-space operations on a target spacecraft. It furthermore relates to a servicing system and to a method for in-space servicing of spacecraft.

Spacecraft in general need to be properly positioned in a predetermined orbit and be properly oriented in the three-dimensional space with respect to their service areas in order to fulfill their respective mission. In other words, they typically are designed to have their telecommunication equipment looking to (or pointing to) the service area. Various forces such as moon gravity, sun gravity, non-uniformity of gravity potential of earth, solar pressure, and atmosphere in low altitudes, and even Venus gravity, plus many other less important forces, interact with the spacecrafts and tend to change their optimum position and orientation. These sources alter the orbital elements of the respective spacecraft effecting what is called orbit perturbations. To counteract these perturbations, spacecraft are provided with thrusters, which are used either in continuous mode or in pulse mode or occasionally, from time to time (i.e. every a few days/weeks/months). Said thrusters consume fuel in order to effect the counteracting forces.

Artificial satellites are a particular case of spacecraft as their mission involves orbiting a specific celestial body in order to be able to provide their service. Other spacecraft have trajectories that may differ for part of their mission from the classical definition of satellite orbiting but still have a service area where they have to point to and accordingly may be negatively influenced by similar perturbations. Usually they become satellites of another celestial body or simply float in space at a Lagrange point or elsewhere. The same nature of problems pertains to all type of spacecraft as regards their orbit and health issues. For reasons of clarity, the following description focuses on a satellite in the proximity of earth and in particular in a proximity that teleoperation capability is not hindered by long electromagnetic wave propagation times, although the concepts may also be relevant to other kinds of spacecraft.

A spacecraft that can be kept, by means of its thrusters, in a desired target postion and attitude is considered under control or controllable, and a non-controllable spacecraft is out of control with regard to its position and attitude. Said controllable spacecraft can be more easily and safely approached for servicing, and is called “co-operative”, while a spacecraft that has lost its attitude control is called “non co-operative”.

Typical spacecraft are designed for a so-called “designed lifetime”. The “designed lifetime” of a spacecraft has a statistical definition. Spacecraft are designed to have an operational lifetime of e.g. 10 years at minimum, with an associated probability 98% (based on the statistical lifetime of the selected components). This means that in the term of 10 years a portion of 2% of the spacecrafts of the same design and material and processes would fail and the rest would continue to function. The average lifetime of the materials of a spacecraft is much longer, sometimes 3 times the “designed lifetime”. For example, the voyager spacecraft still operate after 25 years, while most of the telecommunication satellites have a designed lifetime of 6 to 15 years.

The spacecraft are designed to carry a predetermined amount of fuel, which is calculated in dependence of what they would need to consume during their “designed lifetime”. Consequently, a spacecraft carries fuel only for the designed lifetime (e.g. 10 years) in order to perform all types of maneuvers. At a certain point of time, when fuel reserves finish, a spacecraft cannot retain even its attitude correct and so it becomes useless.

When the fuel reserves are very limited, then the spacecraft can no longer provide the same level of service that it was designed for, or even provide any useful service at all. In this case the spacecraft is rendered useless and abandoned in space creating an additional problem of potential collision with a future operational spacecraft. It becomes as it is called “space debris”.

Fuel-depletion that renders the spacecraft uncontrollable and therefore useless, may happen even earlier than the designed lifetime of the spacecraft for various reasons (e.g simple bad calculation of the fuel budget, wrong positioning due to error, malfunctioning of the launcher, rare phenomena, accident or otherwise, during the launch phase; wrong positioning of the spacecraft during the LEOP (Launch and Early Orbit Phase) due to error, malfunction, rare phenomena, accident or otherwise; change in mission; errors, malfunctions, rare phenomena, accidents, or otherwise during the remaining actual lifetime).

In general, any component, unit, subsystem of a spacecraft, such as sensors, actuators, processing units, inertial subsystems, power subsystem, software, communication payload, may fail due to errors in its use, malfunction, rare phenomena or otherwise that may render the spacecraft partially or totally, temporarily or permanently uncontrollable and therefore unable to function properly to generate the opportunity revenue, or any revenue. It may even create a significant risk for other spacecrafts by its status as space debris. In this definition of space debris we will add to the traditionally conceived one, that regards space debris as passive objects, the characteristic of potentially active object that may be even more dangerous than a passive debris, as an active and unpredictable (accelerating, decelerating) moving object may be.

For both reasons, i.e. lifetime restrictions due to limited fuel resources as well as system failure due to unexpected error, servicing capabilities for spacecraft with the general goal of artificially extending the lifetime of a spacecraft are highly desireable, particularly in view of the typically very high costs involved with replacing an existing spacecraft by a substitute.

Several inventions have been developed for solving the problem of providing servicing capabilities for spacecraft, particularly with respect to failure on satellites and fuel-depletion (U.S. Pat. No. 5,410,731, U.S. Pat. No. 5,813,634, WO 0103310), disclose concepts to inspect the satellites on orbit (U.S. Pat. No. 6,296,205, U.S. Pat. No. 6,384,860), disclose concepts to provide service to them on orbit (WO 9731822, U.S. Pat. No. 4,896,848, U.S. Pat. No. 4,273,305, U.S. Pat. No. 5,299,764, U.S. Pat. No. 4,349,837), or prepare for servicing (U.S. Pat. No. 4,946,596, EP 1 101 699, U.S. Pat. No. 4,657,221). Several others have developed concepts for tools to perform the service (U.S. Pat. No. 4,177,964, WO 0208059) or developed methods for providing new services (EP 1 245 967) for which this invention provides improvements.

Various systems have been studied, wherein the method for performing the rendezvous typically is carried out by manual Tele-operation. In some other documents, autonomous rendezvous and docking systems are proposed.

In the case of autonomous docking mechanisms, the designs that have been proposed involve a robotic arm which demands high dry mass and power budgets.

Patent U.S. Pat. No. 5,299,764 discloses a system for carrying out in-space servicing of spacecraft, wherein artificial life robotics are utilized.

Patent U.S. Pat. No. 6,296,205 discloses a concept of inspecting the RF functioning of a satellite at proximity and emitting control signals and diagnostics to the ground.

Patent U.S. Pat. No. 6,384,860 discloses a video telemetry system for monitoring the deployment of an apparatus coupled to a satellite. This allows the solar panels to be observed during deployment and even before said panels are deployed, but at very low rate (one frame every 27 seconds), said rate not permitting any real teleoperation and any other service.

In the cases where teleoperated designs of service vehicles are proposed these are disadvantaged by the high bandwidth required from the service vehicles to support the teleoperation. To perform an inspection or rendezvous and docking to a satellite a high bandwidth link needs to be established for certain minutes or hours in order to provide sufficient and timely (real time) visual information to the operators and systems on earth to perform the servicing (inspection, rendezvous, docking). Such designs have been proposed resulting in the GSV Geostationary Service Vehicle concept spacecraft.

The disadvantages of this category of prior art are:
High electric power budgets, in order to cope with the required high bandwidth transmission for transmitting timely (in real time) the output of the rendezvous sensors (radar, visual images) towards the ground stations.
High mass budget for the Mission Communication payload, batteries, solar cells, plus structural overhead and overheads to the attitude control subsystem (flywheels, thrusters . . . ).
High volume as result of the above increased budgets (mass, structural overhead, protruding antennas, protruding solar panels).
High complexity due to the redundancy required.
Higher vulnerability to radiation hazards and debris (larger profile).
Low range of operation as regards delta velocity potential.
Large consumption of consumables (fuels, pressurization gas).
Low maneuverability due to high volume and mass.
Higher risks of client due to higher mass and volume and lower maneuverability.
Larger debris problem at end of its life.

The complexity of service missions to orbiting satellites and the high cost involved (space shuttle cost is 500 M$ per flight) has rendered the idea of servicing ailing satellites as a solution to restore or prolong service unattractive. As an alternative, putting into orbit universal back-up satellites or specifically designed, individual backup satellites is considered.

The Geostationary satellites in order to reach their orbit need to use some kind of launch vehicle of which vehicle either the last part (upper stage) or the apogee kick motor is jettisoned in the space close to the geostationary ring creating space debris. Said debris constitutes a high hazard potential for future missions. Some recent satellites use a Unified Propulsion System for reaching geosynchronous orbit from their injection point and for orbit maintenance. This solution saves one piece of debris but results to higher mass overheads for the duration of the entire life of the satellite. At the end of life of the satellite the totality of it becomes space debris.

Up to now, almost no spacecraft has been designed to be refueled or be serviced in space. As one result of this design philosophy, a large part of space debris consists of spent spacecrafts and apogee kick motors and upper stages.

Therefore, it is an object of the present invention to provide a particularly versatile and flexible service vehicle for performing in-space operations on a target spacecraft. Furthermore, a servicing system and a method for in-space servicing of spacecraft shall be provided.

With respect to the service vehicle, this object is achieved with a communication module which with respect to its transmission and/or receiving characteristics is configurable in order to meet given receiver and/or transmitter parameters of said selected target spacecraft.

The services provided by the service vehicle may include any types of services, such as refueling, delivering all kinds of material, repair or maintenance services, or other kinds of suitable activities. Said services may collectively be denoted as ACR for Assembly, Convert and Repair. The majority of said ACR services are to be performed by means of teleoperation assisted by stereoscopic means, illuminating means & tape-tools that assist in fetching/storing tools and fetching/storing spares and fetching/storing disassembled components.

The invention is based upon the concept that for flexible and versatile servicing of a target spacecraft, the service vehicle ought to be designed for a particularly low mass, energy and/or fuel budget. However, a significant contribution to both mass and energy/fuel requirements is the necessity to constantly provide for reliable communication between the service vehicle and a ground control station, in particular in view of the comparatively large distances that must be overcome between ground control and service vehicles in expected servicing missions. In order to significantly lower the onboard power consumption on the service vehicle necessary for maintaining a reliable communication channel with ground control, the service vehicle is designed for emitting signals to and/or receiving signals from ground control by using the target spacecraft to be serviced as a relay station. In this concept, the energy required from the service vehicle may be limited to maintain a communication channel with the target spacecraft, and accordingly the mass required to provide these lowered energy levels—i.e. accumulator mass—may be kept correspondingly low. The major share of the energy necessary to maintain proper communication in this concept is then delivered by the target spacecraft which as such is designed for communicating with ground control anyway. In order to render the target spacecraft useable for this purpose, the service vehicle is designed to be configurable to establish communication contact with the target spacecraft.

Particularly advantageous features of the present invention are specified in the dependent claims.

Preferably, the configurable communication module comprises a transmitter to emit communication signals to the target spacecraft. Alternatively or additionally, in a preferred embodiment the communication module is equipped with an adjustable or configurable receiving unit, thus allowing the communication module to be set up to receive input or command signals from various selectable sources. In a particularly cost- and budget-effective setup, the receiver preferably is designed adjustable in its working frequency in order to communicate with a telemetry channel of said selected target spacecraft. In this configuration, the so-called telemetry channel, which in typical space-craft designs for safety reasons has a comparatively wide-spread emission characteristics, may be used to relay command or input signals from ground control to the service vehicle. In this way, available frequency ranges may be used in a very efficient way for communication with the service vehicle.

In a preferred embodiment, the service vehicle is designed with particular emphasis on the concept to keep the target spacecraft safe from over-extensive or potentially destructive energy input from the service vehicle while also providing for a comparatively high range of distances to the targed spacecraft over which reliable communication may be established. In order to achieve these accumulated goals, which with respect to the output power emitted by the service vehicle contradict each other, the service vehicle preferrably is designed for variable output power of its communication module. For this purpose, the service vehicle preferrably is equipped with a control module for providing a setpoint for an output power of said configurable communication module. In further preferred embodiments, the setpoint for the output power is chosen in dependence of the current distance between service vehicle and target spacecraft and/or the relative orientation of the target spacecraft with respect to the service vehicle. Accordingly, the control module preferrably inputwise is connected to a first position sensor, said first postion sensor delivering a set of data characteristic for the current position of said service vehicle, to a second position sensor, said second position sensor delivering a set of data characteristic for the current position of said target spacecraft, and/or to an orientation sensor, said orientation sensor delivering a set of data characteristic for the current orientation of said target spacecraft in relation to said service vehicle.

In a particularly advantageous embodiment, which may also be used independently from the communication concept as identified, the service vehicle is designed for reliable and easy-to-use docking at the target spacecraft. For this purpose, it preferably comprises a docking system, said docking system comprising a hollow first axle inside of which a second axle is moveably disposed, said second axle carrying an activateable arrow tip. For docking purposes, the activateable arrow tip may be inserted into the exhaust system of the thrusters of the target spacecraft via the axle system. Once inserted into the interior of the exhaust system, the arrow tip, preferably a double-arrow tip, may be activated in order spread the arrow fingers apart. Retracting the arrow tip via the axle system will then cause the arrow tip to engage with the side walls of the engine exhaust, thus providing for reliable docking at the target spacecraft.

With respect to the servicing system, the object identified above is achieved with a service vehicle as described above, further supplemented by a ground control unit for delivering operational commands to the service vehicle. In order to consequently use the target spacecraft for relaying communication signals from the service vehicle to ground control in this servicing system, the ground control unit preferably is set up to receive data from the service vehicle by using the target spacecraft as a relay station for signals emitted from the service vehicle.

The servicing system may further be supplemented by an orbit-based service base for the service vehicle and/or by a propulsion module attachable to said service vehicle.

With respect to the method for in-space servicing of a selected target spacecraft, the object identified above is achieved in that a service vehicle as identified is used to perform selected in-space operations on the target spacecraft, whereby operational signals from the service vehicle are transmitted to a ground control unit by using the target spacecraft as a relay station for the operational signals.

Alternatively or additionally the object identified above is achieved in that a service vehicle as identified is used to perform selected in-space operations on the target spacecraft, whereby a telemetry channel between a ground control module and the target spacecraft is used to relay command signals to said service vehicle. In this setup, the telemetry channel which is auxiliarily used to echo telecommands can echo telecommands destined to service vehicle as well.

Among others, the main advantages of the present invention are that particularly inexpensive apparatus and methods for performing particularly inexpensive science missions from space, requiring consumables or/and robotic facilities, are provided. Furthermore, particularly inexpensive apparatus and methods for altering orbits of passive or active objects in space for whatever reason (anti-collision, operational) or maintaining its position against perturbing forces are provided as well as inexpensive apparatus and methods for effecting reconfiguration, maintenance and/or assembly operations. Still furthermore, the invention pertains to reusable synergetic apparatus and methods for performing inexpensively a variety of proximity operations, e.g., inspection of an operational or non-operational satellite, to determine its status, (its weight, its temperature profile, the operation or its subsystems), and/or to reusable synergetic apparatus and methods for inexpensively delivering or replenishing supplies to orbiting spacecraft or complexes such as the international space station.

Furthermore, to ground or elsewhere a high bandwidth telecommunication link originating from a simple inexpensive low powered servicing module is provided, optionally together with a simple method of controlling a spacecraft through part of the telemetry produced by another spacecraft, and/or an inexpensive apparatus and method for recovering telemetry information from a spacecraft whose telemetry means transmit at very low power. Still furthermore, the invention provides apparatus and method for recovering telemetry information from a spacecraft whose telemetry means transmit in very low power and encrypt it before retransmission through on-board means or through means of the serviced spacecraft, and/or an inexpensive simplified mechanical grip for capturing a satellite from the interior of the combustion chamber of the satellite and method of securing the grip, resulting to a pair of bodies (satellite & service module) of high stability.

With the receiver setup to communicate via the telemetry channel it is also very easily possible to use telemetry data exchanged between the target spacecraft and service vehicle for real time diagnostics.

An in-space service vehicle, in order to provide even the minimum of services, namely inspection, it requires to be equipped with one or more cameras and means to establish an associated High Bandwidth Communication Link (HBCL) to the ground. Through this link it provides in real-time, the visual or infrared or other high bandwidth information that is captured, to teleoperators at the ground, to enable teleoperation. The said link requires very demanding resources (power, telecommunication means), especially if the service is to be offered at the geostationary ring level.

The method in accordance with the invention includes usage of telecommunication means of said satellit for the transmission of the said images to teleoperating controllers at the ground segment and not effecting as usually has been proposed, the link directly to the Ground Stations in an autonomous manner. The service vehicle proposed possesses means for transmitting at low power and at the frequency of an operational up-link transponder of the target spacecraft 2 the video signal properly modulated. The satellite shall retransmit as normally the respective converted and amplified signal through the respective down-link transponder. Preferably, the up-link transponder of the operational transponder chosen for the said link shall cease operation during the service mission to allow unhindered image reception to the Ground Segment.

An examplary embodiment of the present invention is explained in greater detail with reference to the drawings in which:

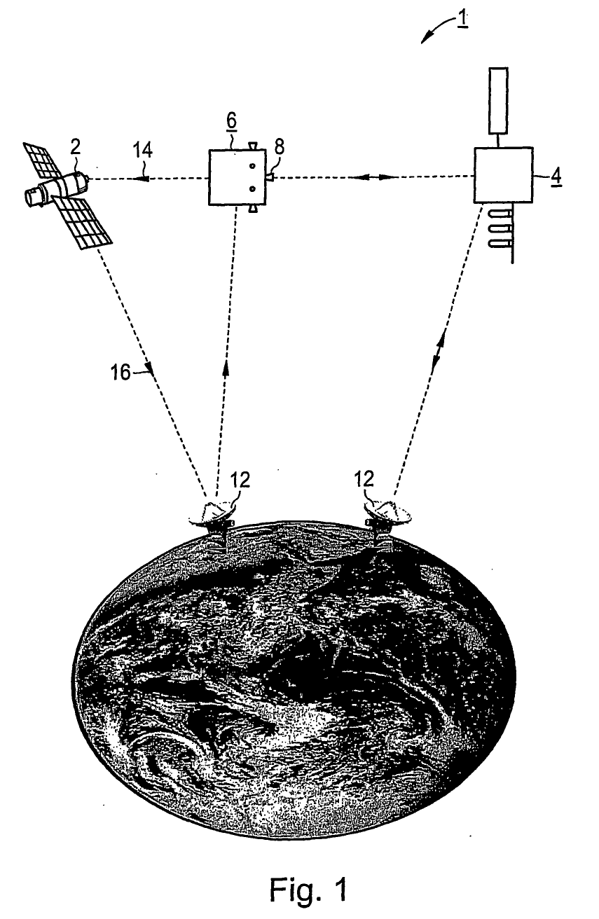

FIG. 1 shows a first version of a servicing system for providing in-space service operations to a selected target spacecraft,

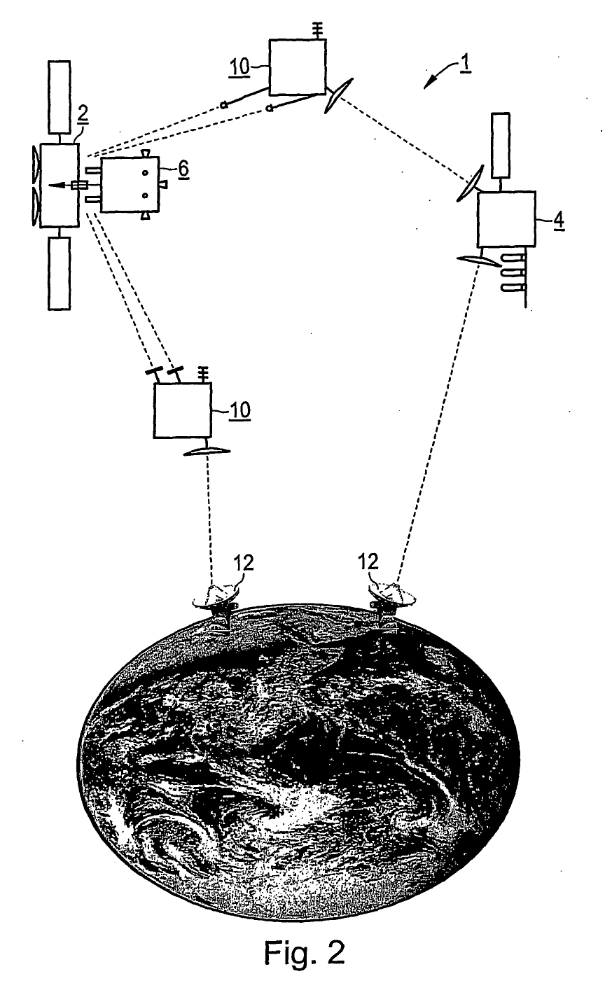

FIG. 2 shows a second version of a servicing system for providing in-space service operations to a selected target spacecraft,

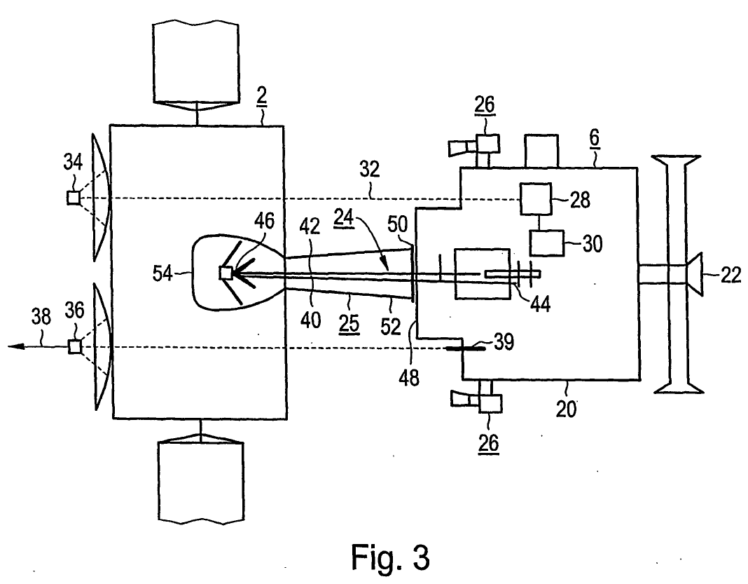

FIG. 3 shows a service vehicle of the servicing system according to FIG. 1 or FIG. 2 docked to the target spacecraft,

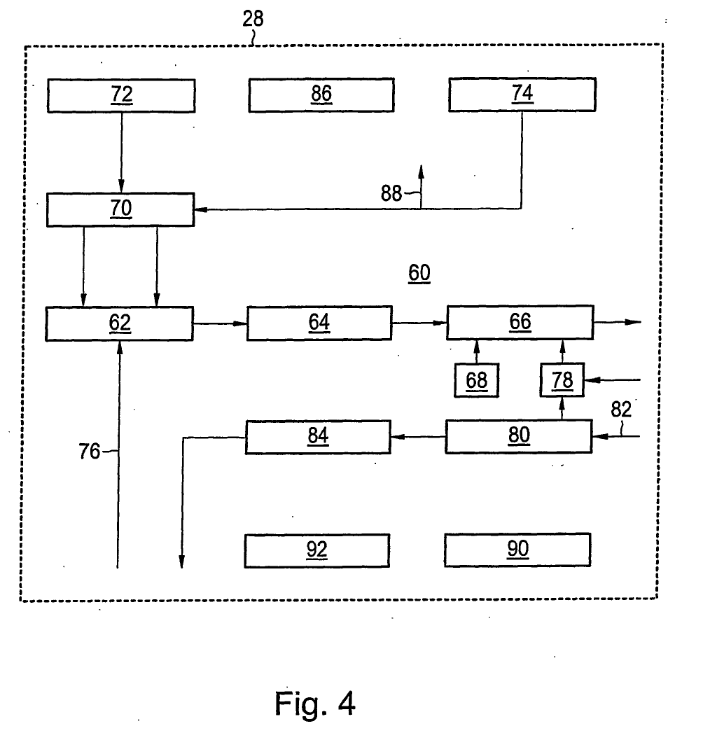

FIG. 4 shows a schematic structure of the communication system of the service vehicle according to FIG. 3,

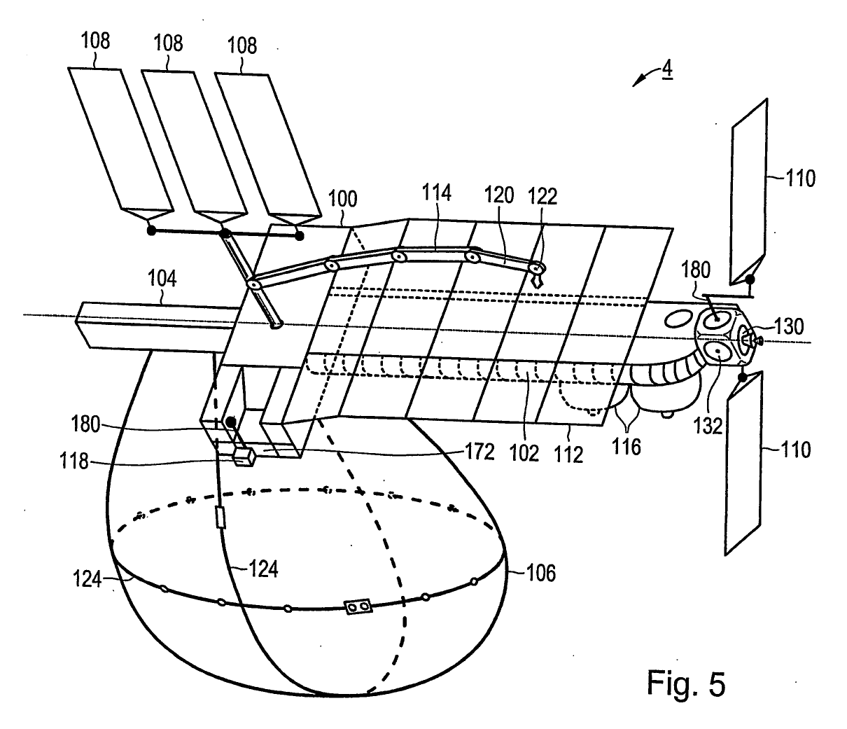

FIG. 5 shows a utility base of the servicing system according to FIG. 1 or FIG. 2,

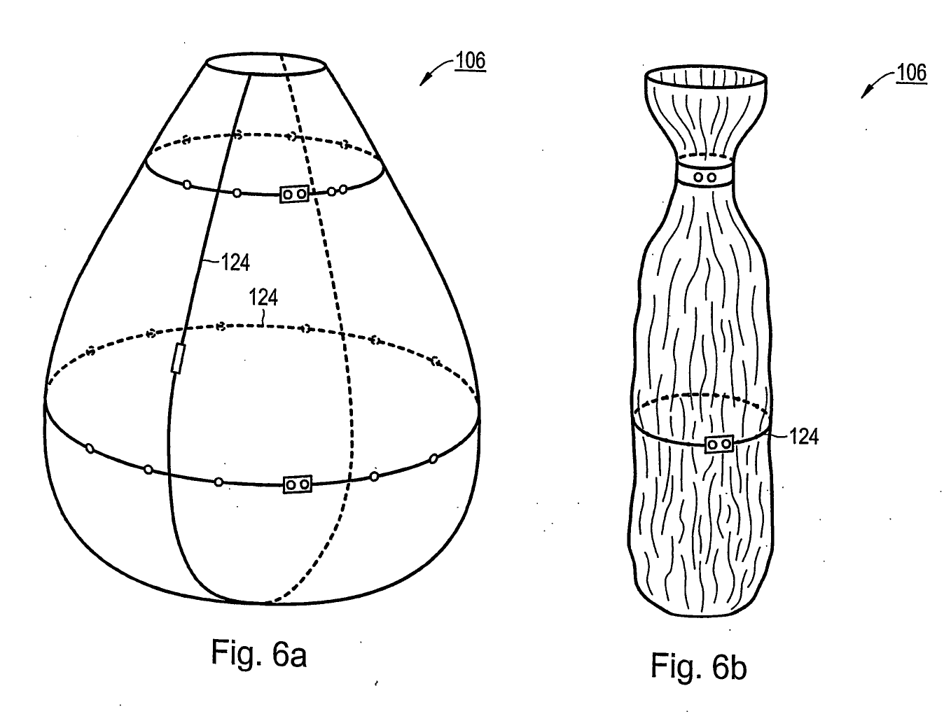

FIGS. 6a, b show a flexible storage module of the utility base according to FIG. 5 in inflated (FIG. 6a) and deflated (FIG. 6b) condition, respectively,

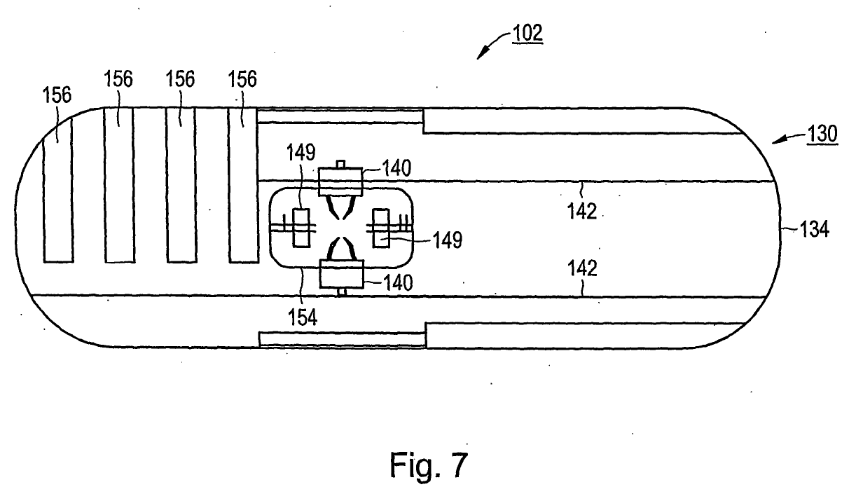

FIG. 7 shows a schematic view of the internal layout of an equipment and storage bay of the utility base according to FIG. 5,

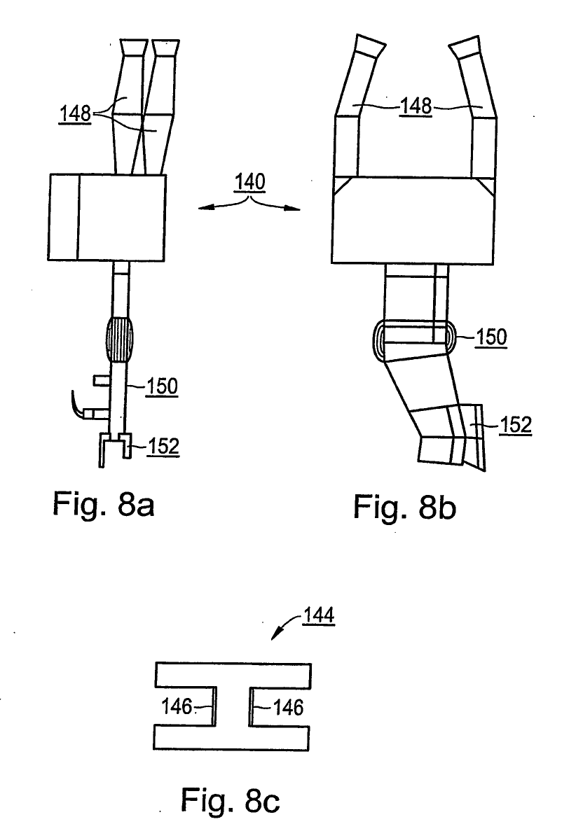

FIGS. 8a-c show a robotic manipulator for use in the interior of the equipment and storage bay according to FIG. 7 in side view (FIG. 8a) and in top view (FIG. 8b) and a cross section of a rail system for the robotic manipulator (FIG. 8c),

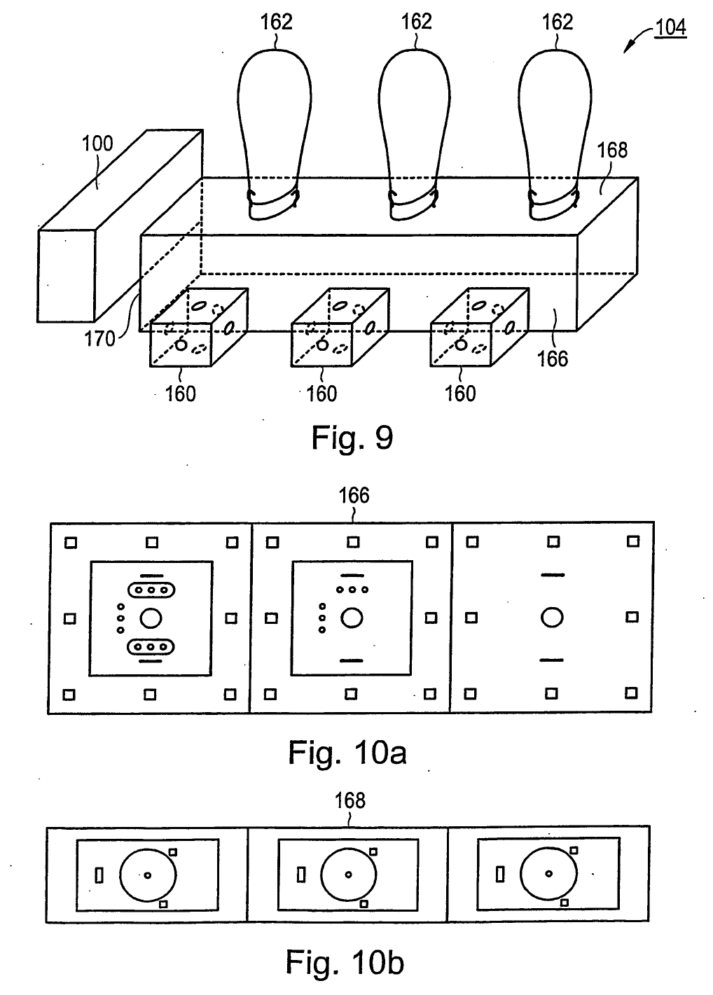

FIG. 9 shows a docking and refueling rack of the utility base according to FIG. 5,

FIGS. 10 a, b show a side panel (FIG. 10a) and a top panel (FIG. 10b) of the docking and refueling rack according to FIG. 9,

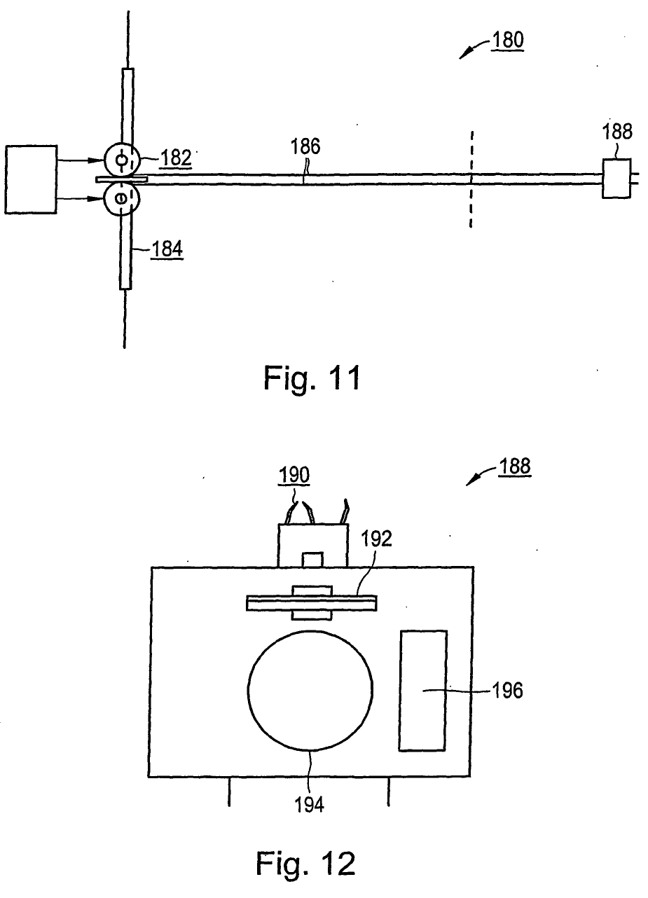

FIG. 11 shows a catch system, particularly for use in the utility base according to FIG. 5, and

FIG. 12 shows an action tip for the catch system according to FIG. 11.

In all figures, identical parts are provided with identical reference numerals.

Following terms as used herein mean:

Spacecraft: is any type of manmade apparatus that is launched in space as a whole or produced through assembly in space.

Satellite: is a spacecraft that has entered a roughly determined orbit around a celestial body (planet, natural satellite or sun). “Orbital elements” are called the set of parameters that are describing this orbit.

Delta velocity: is the velocity increment or decrease of a spacecraft with respect to its vector of motion, by the application of a force that is called trust and is provided through the thrusters of the spacecraft.

Total delta velocity potential: is the cumulative sum of the delta velocity a spacecraft can generate throughout its operational life.

Geostationary object: is an object that has an eastwards circular orbit around earth at a height of about 35,786.4 KM above the sea level. Characteristic of tremendous significance of this orbit is the fact that the object rotates with the same angular velocity as the earth and so it is visible as stable above the equator at certain Longitude, making possible the continuous communication with it through a single stably pointing antenna. The sub-satellite point is stable and is located at a certain longitude at the equator.

Station keeping maneuvers: are these maneuvers that are required to put or return a spacecraft to its desired point (or trajectory for missions with no stable sub-satellite point eg Molniya) of operation.

Fail-Safe: a technical characteristic of an apparatus that is designed in such a way that when it fails for any reason it does not pose a risk apart from the loss of service it is designed to offer.

The servicing system 1 according to FIGS. 1 and 2 is designed to provide in-space service operations to a selected target spacecraft 2, in particular a target satellite, at both high reliability levels and low fuel/cost levels. In this context, the sevicing system is designed to provide the services both to so-called cooperative (or controllable) targets as is shown in FIG. 1, or to non cooperative (or non controllable) targets as is shown in FIG. 2.

In order to provide services in a broad variety of missions, typically in each mission type units of several, in particular three, species are used. These various species of spacecraft, in various numbers depending upon mission, co-operate in a synergetic manner in order to provide a service to the target spacecraft 2, either cooperative or non-cooperative.

As a first element, the servicing system 1 comprises a module serving as a utility base 4, in the role of mothership for further elements. The second element, a service vehicle 6, has the role of the actual service provider to the target spacecraft 2 and may also be referred to as a “Utility Agent service vehicle 6”. A third element is an engine module 8, potentially a subset of the service vehicle 6, suitable for permanent orbit maintenance service on a cooperative target. As fourth element, a specialized vehicle 10 for missions with non-co-operative targets, or for carrying and operating specialized repairing means or communication relay means, also referred to as “Escort Agent EA” may be provided.

By use of the servicing system 1, the existing fleet of spacecraft can be adequately serviced and upgraded, and future spacecraft can be produced at much lower cost, much lower mass and much shorter time, making use of the advanced repairing and upgrading capabilities of the service fleet of the servicing system 1. Operational life of spacecraft is extended, capabilities are augmented, space debris problem is mitigated. In this context, the service vehicle 2 is designed to provide a series of operations dissimilar in nature and complexity. In general, a single service vehicle that would embody all potential characteristics would be too expensive to construct, as many studies have shown. Furthermore, its size and weight would increase the risk and operational cost. Taking into account the potentially large variety of mission types and that it would require to perform high and often changes in velocity any saving in weight budget would pay back many times.

Therefore, the service vehicle 6 is designed for particular weight-effectiveness and flexibility. This primary goal is achieved by the fundamental design philosophy that it is specially designed to be teleoperated through a high bandwidth link via the target spacecraft 2 itself. On that respect it remains autonomous from the utility base 4 for long although small and it gains reusability potential by the means of the utility base 4. Accordingly, in order to allow for low energy consumption and the corresponding savings in weight (i.e. for energy storage devices such as batteries), the service vehicle 6 is designed to communicate with a ground control module 12 via a relay station. In the operating mode as shown in FIG. 1, the target spacecraft 2 itself is used for relay purposes. As indicated by the arrows 14, 16, signals emitted by the service vehicle 6 are transmitted to the target spacecraft 2, thus according to close proximity demanding only limited transmission power. The service vehicle 6 emits the signals to the target spacecraft 2 in such a way that the target spacecraft 2 is operated to forward the signals to the ground control module 12, for this purpose providing the required (comparatively high) transmission power from ist onboard energy sources.

In case a non-cooperative target spacecraft 2 is to be serviced, as sis shown in FIG. 2, the service vehicle 6 may be accompanied by a specialized vehicle 10 in this context providing the necessary transmission power.

In order to facilitate using the target spacecraft 2 for the intended relaying purposes, the service vehicle 6 is equipped with a communication module that can be configured such that it can communicate with an arbitrary target spacecraft 2 in order to command it to forward incoming signals to ground control module 12.

The service vehicle 6 is shown in more detail in a position docked to the target spacecraft 2 in FIG. 3. Within an outer main body 20, a plurality of servicing facilities (not shown in detail, but selected appropriately to provide the service required) is disposed. Attached to the main body 20, there is a separable propulsion system 22 mainly based on the use of conventional thrusters. In order to firmly attach itself to the target spacecraft 2 after the final approach, the service vehicle is equipped with a docking system 24 designed to engage with the exhaust system 25 of the target spacecraft 2. In order to provide visual information for final approach, or to inspect the target spacecraft 2, a number of cameras 26 is attached to the main body 20.

The service vehicle 6 is equipped with a built-in communication system 28, which datawise is connected to an altitude and orbit control system 30 of the service vehicle 6. The communication system 28 is designed to, at close enough distances, establish a communication channel with the so-called up-link communication channel of the target spacecraft 2. For this purpose, as indicated by the dashed line 32, the communication system 28 establishes a communication channel with a receiver 34 of the up-link channel of the target spacecraft 2. Via this communication channel, the communication system 28 transmits commands or signals at a comparatively low output level that within the target spacecraft 2 are relayed and forwarded to the emitter 36 of the so-called down-link channel of the target spacecraft 2. As indicated by the arrow 38, the signals are then forwarded via the down-link channel to the ground control module 12 at a comparatively high transmission power, the enegry for which is derived from the on-board energy sources of the target spacecraft 2.

For easier maneuvering relative to the target spacecraft 2, the service vehicle 6 is equipped with a laser unit 39 set up to identify the distance of the service vehicle 6 from the target spacecraft 2.

The docking system 24 of the service vehicle 6 mainly comprises a hollow axle 40, an activation axle 42 inside the hollow axle driven by a fail-safe mechanism 44 that allows extension, retracting or rotation of the hollow axle. At the free end of the activation axle 42, a double arrow opening tip 46 (one arrow being smaller than the other) is provided. The double arrow opening tip 46 is opening by means of retracting the activation axle 42 and an even surface around the activation axle 42 to permit even contact of the front surface 48 of the service vehicle 6 with the nozzle ring 50 of the exhaust channel 52 of the target spacecraft 2, providing high stability when engaged.

The method of docking consists of the following phases: alignment of axle 40 to nozzle 50, entering the activation axle 42 into combustion chamber 54 of the target spacecraft 2, opening of the arrowheads, rotation if needed with stepwise retracting, final retracting of hollow axle 40 and fail-safe engaging of the double arrow opening tip 46 with the interior of the combustion chamber 54.

At approaching the target spacecraft 2, the arrow head sides shall be aligned parallel to the axle 40. The axle 40 is guided towards the center of the combustion chamber 54 through the nozzle 50 and when it passes the neck of the chamber 54 the arrow head sides are opened wide to the maximum, through retracting the activation axle 42 in order to secure it inside the combustion chamber 54. If the angular alignment between service vehicle 6 and target spacecraft 2 is satisfactory then the securing and safeing phase is started, if not then the mechanism 44 retracts the hollow axle 40 and rotates the activation axle 42 in successive steps until the desired angular alignment is achieved. Then the retreating mechanism 44 retreats slowly and firmly the hollow axle 40 until the surface of the service vehicle 6 reaches and presses onto the nozzle end-ring of the target spacecraft 2. The activation axle 42 is fail-safe secured at this position and is released only by command or if a general failure occurs. In case of a power failure or mechanical failure or processing failure the activation axle 42 is left to its natural position by means of a spring that forces the arrowheads close. An independently powered timer controls the safeing mechanism. As long as the anomaly detection mechanism has detected no anomaly threatening the target spacecraft 2, the activation axle 42 pushes open the arrowheads. In the case a threatening anomaly is detected the activation axle 42 is left free and, forced by a spring, lets the arrowheads close. Any forward movement of the target spacecraft 2 lets the service vehicle 6 to free float in space.

The structure of the communication system 28 of the service vehicle 6 is shown schematically in FIG. 4. As a key component, the communication system comprises a communication module 60 which is designed such that with respect to its transmission characteristics it may be configured in order to meet given receiver parameters of the selected target spacecraft 2. Accordingly, by proper configuration of the communication module 60, communication with any kind of target spacecraft 2 may be established and hence the service vehicle 6 can be teleoperated by using the target spacecraft 2 for relaying signals.

The communication module 60 comprises a multiplexer 62, connected to a signal modulator 64. Multiplexer 62 together with modulator 64 generate the signals to be transmitted. For transmission purposes, the communication module 60 further comprises a transmitter 66 in connection with the modulator 64. For configurability, the transmitter 66 is equipped with a controller module 68, which if supplied with the required data format may reconfigure the transmission characteristics of the transmitter 66 on a software basis. Furthermore, within the communication module 60, the transmitter 66 is exchangeable. Accordingly, configuration of the communication module 60 may also be carried out in a hardware manner by providing an alternative transmitter 66. Since there are a plurality of satellite types or categories, preferable configuration is carried out on a hardware basis, i.e. by replacing the transmitter 66, if reconfiguration bewteen different target spacecraft categories is desired, whereas reconfiguration is done on a software basis, i.e. by reprogramming the controller module 68, if reconfiguration between different individual target spacecraft of the same category is desired.

Inputwise, the multiplexer 62 is connected to an encoder 70, which in turn receives its input data from a camera 72 and/or a proximity sensor 74. Furthermore, the multiplexer 62 inputwise is also connected to a telemetry system as indicated by the arrow 76.

With respect to its output power, the transmitter 66 is adjustable in order to make sure that the power emitted will not endanger or destroy the target spacecraft 2 due to close proximity. Accordingly, the transmitter 66 is equipped with a control module 78 designed to provide an appropriate setpoint for the output power. The control module preferably generates the setpoint for the output power based upon a signal strength received from the target spacecraft 2, which is characteristic for the relative distance of the service vehicle 6 from the target spacecraft 2. Accordingly, inputwise the control module 78 is connected to a communication receiver 80 of the communication system 28. The receiver 80, which inputwise receives signals from the target spacecraft 2 as indicated by the arrow 82, outputwise is connected to general data handling of the service vehicle 6 via a demodulator 84. Further components, such as a docking subsystem 86, the proximity sensor 74 directly via a branch line 88, retroreflectors 90 mainly used for other spacecraft to dock on, or an optional refueling module 92 are also connected to a telecomand bus or general data handling of the service vehicle 6.

The receiver 80 is adjustable in its working frequency in order to communicate with a telemetry channel of the target spacecraft 2. Accordingly, by ground setup of the communication parameters, esp. frequency, of the receiver 80, control or command signals may be sent to the receiver 80 by using the so-called telemetry echo channel of the target spacecraft 2. In this configuration, command or control signals for the service vehicle 6 may be included into the data stream sent to the target spacecraft 2 in the conventional telementry channel. Preferably in this case the command or control signals are provided with an associated identification element or tag. In the target spacecraft the data elements identified in this way can be re-emitted in the telemetry echo channel to be picked up by the receiver 80. In accordance with their identification, these signals can then be forwarded for further processing in the service vehicle 6. This specific setup in principle makes if possible to design the service vehicle 6, which in particular may be a utility agent or an engine module, without a seperate navigation system since the entire telemetry information from the spacecraft 2 may be forwarded to the service vehicle 6.

Beyond, the functional composition of the bus system of the service vehicle 6 comprises the following subsystems: a structure subsystem, the data handling subsystem (DHSS), an electric power subsystem (EPS), a thermal control subsystem (Ttarget spacecraft 2), an attitude orbit & control subsystem (AOtarget spacecraft 2), a telemetry tracking & control subsystem (TT&C), and a propulsion subsystem (PSS), characterized by no redundancy in any of the subsystems budgets.

Albeit the fact that these subsystems are present in the majority of spacecrafts the bus of the service vehicle 6 is characterized by low capability budgets of the respective subsystems, in account of its mission and the lack of redundancy. The lack of redundancy is justified by the capability, in case of failure of a given fleet unit, of recovering it through another service vehicle 6 or specialized vehicle 10 and subsequently repairing it at the utility base 4.

In particular, the EPS consists of small solar cell array panels (SAP) capable to produce part of the energy required during missions. Start of mission charging is performed at the utility base 4 before the mission starts. Likewise, the batteries of the service vehicle 6 are undersized, as at proximity to the utility base 4 the telemetry is relayed through the utility base 4, at cruise if needed directly to earth and then at approach of the target spacecraft 2 through the target spacecraft 2. At proximity to the target spacecraft 2, the target spacecraft 2 is used as relay for both the TT&C and the cameras output. The EPS does not cater for any high-bandwidth link to support teleoperation or robotic facility or both as it is usually being proposed. Considering that the EPS of a typical spacecraft is 30% of its mass budget this saving is of high importance.

The TT&C transmitter is of low bit-rate and characterized by the use of Adaptive Power Control APC. The TT&C transponders can be switched off when in proximity to the target spacecraft 2. In this case the telemetry TM and telecommand TC are transferred through the payload.

The service vehicle 6 to perform docking and operations establishes one forward link with the teleoperators, preferably at ground control module 12, and a return link both through the target spacecraft 2.

The forward link is established as follows: The encoder 70 of the service vehicle 6 payload receives two inputs, one for the signal of the camera 72 and one for the proximity sensor 74 and generates two encoded signals for the camera signal and the proximity sensor respectively. The multiplexer 62 receives these two signals plus the encoded TM signal from the DHSS of the bus and multiplexes the three, producing a composite signal. The modulator 64 receives the composite signal, produces a modulated signal and feeds the transmitter 66 which amplifies and transmits the signal that is fed to the up-link receiver of a channel of the target spacecraft 2. The target spacecraft 2 receives the signal and transmits to the ground. The transmitted signal arrives through the ground control module 12 at a Mission Control Centre (MCC) for analysis and informed action.

The teleoperators in the MCC generate telecommands for the service vehicle 6, which are embedded within the telecommands for the target spacecraft 2. These telecommands for the service vehicle 6 are flagged with the request only to echo them and not to be executed by the target spacecraft 2. Following the reception of the telecommands the target spacecraft 2 echoes them from the telemetry channel. This signal is easily intercepted by telemetry receiver of the service vehicle 6.

The telecommand reception is established as follows: The telemetry listen-in receiver receives the totality of the telemetry of the target spacecraft 2 and produces a signal that forwards for demodulation at the demodulator 84. After demodulation the resulting signal is forwarded to the DHSS of the bus and in particular at the application software where the analysis of telemetry is performed for extracting this information that consists commands to the service vehicle 6.

The main types of operation of the service vehicle 6 in relation with a mission are cruising from the utility base 4 which is serving as a starting platform for each mission, approaching the target spacecraft 2 (rendezvous and teleoperation), return from the target spacecraft 2 to the utility base 4, and resting at the utility base 4 until the next mission for the respective service vehicle 6 is started.

When cruising from the utility base 4 to the target spacecraft 2 (“Cruise mode”), the service vehicle 6 travels from the utility base 4 to the target spacecraft 2 alone and autonomously making use of the star tracker. The power output of the TT&C of the bus is adjusted so that telemetry link can be established by the bus TT&C through either the utility base 4 or the target spacecraft 2. If neither is possible due to large distances, the service vehicle 6 may be escorted in the needed part of its cruise by a specialized vehicle 10, may be used to relay telemetry and telecommands from a ground control module 12 to the service vehicle 6 and vice-versa, thus rendering the service vehicle 6 operable in any state of the cruise in spite of its limited on-board transmission and fuel capacities.

For rendezvous and teleoperation, during the coast phase from the utility base 4 to the proximity of the target spacecraft 2 the star images from the cameras 26 are used for autonomous navigation. During the approach and rendezvous phases the service vehicle 6 is controlled by means of open loop successive command cycles until docking is secured.

At each command cycle the real-time output of the cameras 26 is encoded, multiplexed, and modulated together with telemetry information of the service vehicle 6 (and optionally with the output of the proximity sensor 74). The resulting signal is transmitted by the low power transmitter 66 to an up-link channel of the target spacecraft 2 through its up-link antenna. The target spacecraft 2 retransmits through the respective down link channel said signal to the ground control module 12 which may be part of a ground station (GS) and mission control center (MCC). The receiver of the ground controil unit 12 receives the composite signal, demodulates and de-multiplexes and then decodes the image, telemetry and proximity sensor signals and forwards them to the MCC. The telemetry information and proximity sensor information is recorded at the MCC, analyzed and several derivative parameters are generated to optimize motion commands of the teleoperation apparatus. Said optimization compensates for fuel mass changes, sloshing activity, thruster efficiency, fuel temperature, combustion chamber temperature and other biasing factors difficult to be handled by an operator in real time. The real-time image together with the summary proximity information and other rendezvous related information (relative angles, time windows of critical steps, fuel reserves etc) is displayed onto virtual-reality head-on display systems of a plurality of teleoperators.

Said teleoperators have control over actuators generating appropriate commands which pass through the above said optimization. Said optimized telecommands are packed in special telecommands of the target spacecraft 2 and are forwarded from the MCC to the transmitting part of the ground control module 12, encoded, modulated and transmitted as part of the telecommand stream to the target spacecraft 2 with appropriate identification. The telecommands that are addressed to the service vehicle 6 are echoed by the down link (telemetry) of the TT&C of the target spacecraft 2 and listened-in by the TT&C receiver of the service vehicle 6. The listened-in telemetry signal is demodulated and decoded and a telecommand selector parses the telemetry and selects telecommands addressed to the service vehicle 6. The said telecommands are executed and telemetry is generated that in turn is encoded, multiplexed with the outputs of the cameras 26 and proximity sensor 74, modulated and then transmitted to the selected up-link channel of the target spacecraft 2.

This command cycle is repeated until the docking system 24 is securely fastened inside the combustion chamber 54 of the target spacecraft 2.

Upon mission completion or fuel shortage, the service vehicle 6 returns to the utility base 4 for resting or refueling, respectively.

In proximity to the utility base 4, maneuvering of the service vehicle 6 is assisted by the surveillance means of the utility base 4. The service vehicle 6 assisted by the utility base 4 sensors and retroreflectors performs preferably an automatic docking at the utility base 4. However, teleoperated docking may also be performed.

In the “resting mode”, under service-call wait-status, the service vehicle 6 rests, preferably at the utility base 4, preferably in a storage mode that consumes very limited resources. It is envisaged that, at full deployment, there will be provided a multitude of service vehicles 6 at a single utility base 4 with some variations in size and interfaces to correspond to specific types or categories of target spacecraft 2, or to better a match a selected type or level of service to be provided to the target spacecraft 2.

In case that the target spacecraft 2 requires specific services from subsystems of the utility base 4 (robotic facility), the service vehicle 6 may be operated to fetch the target spacecraft 2 to the utility base 4 for servicing and places back to the desired post after service (“porting mode”).

The service vehicle 6 depending of the mission duration may be equipped with additional fuel reserves and a fuel delivery subsystem. In another variation, the service vehicle 6 may be designed to perform a variety of missions with add-on accessories. For example, a service vehicle 6 equipped with drilling means and endoscope may be used in tandem with a specialized vehicle 10 for performing indepth investigations of failure causes or other rescue missions.

The engine module 8 of the service vehicle 6 primarily is used for orbit maintenance of a target spacecraft 2 and for potentially reserving fuel of a target spacecraft 2. The engine module 8 comprises a subset of elements of the service vehicle 6. In particular, the bus of the engine module 8 may be part of the attitude and orbit control subsystem if the mission is propulsion only. Its payload consists of a fail-safe docking-securing mechanism identical with the one of the service vehicle 6 and a TT&C that interfaces with the TT&C of the target spacecraft 2 in a way similar to the concept of the service vehicle 6. This TT&C comprises a telemetry listen-in receiver-demodulator-decoder-command selector and an encoder-modulator-transmitter that transmits to the up-link of the TT&C channel or other channel, as preferably of the target spacecraft 2.

The engine module 8 possesses electrical and data interfaces for mating with a porting service vehicle 6, and optionally a fuel reception inlet. It disposes at all sides retroreflectors that facilitate automatic docking of a visiting or refueling service vehicle 6. The engine module 8 may be used to be forwarded and attached to a target spacecraft 2 by means of a service vehicle 6. When mission fuel depletes it receives additional fuel by a refueling service vehicle 6. Return to the utility base 4 may then require a porting service vehicle 6. In case of critical failure the fail-safe mechanism is automatically released.

The level of redundancy of the engine module 8 is customizable according to mission requests. An engine module 8 for a target spacecraft 2 with no fuel reserves preferably has full redundancy. An engine module 8 for a target spacecraft 2 with fuel sufficient for a few months operation may be designed with no redundancy.

At full-scale deployment of the servicing system 1, a plurality of utility bases 4 may be held available. The most preferable position to start with is the geostationary ring, less preferable the low earth sunsynchronous polar orbit. Any other possible orbital plane is object for positioning a utility base 4 but markets other than that of the geostationary ring and the sunsynchronous polar orbits need still to be matured.

The utility base 4, which is shown in FIG. 5 in more detail, represents the mother ship for service vehicles 6 or other vehicles 10 of the servicing systen 1. As main components, the utility base 4 comprises a main body 100, which primarily houses control systems and the like and contains the bus system of the utility base 4, an equipment storage bay 102, a docking/refueling rack 104, and a flexible storage module 106. The interfaces between these segments dispose power, data “TMTC” and plurality of video signal connectors.

Attached to the main body 100, primary solar panels 108 are provided for energy supply. For redundancy purposes, secondary solar panels 110 are attached to the equipment/storage bay 102. The equipment/storage bay 102 further carries a support grid 112 for securing and storing items if needed. In order to potentially move items around, a robotic arm 114 preferably extending beyond the support grid 112 is mounted onto the main body 100. For establishing communication channels, a number of reflectors 116 of antenna are attached to the equipment/storage bay 102. The primary and redundant large aperture parabolic antennas are mounted onto the down-out side of the equipment/storage bay 102.

In order to allow for docking of a multitude of service vehicles 6 or specialized vehicles 10, especially for resting purposes without the need for supplying the respective vehicle further, the utility base 4 is equipped with a number of docking stations 118. Although in FIG. 5 only one docking station 118 is explicitly identified, further docking stations (preferably at least four in total) are provided, preferably at least one in every main direction of the utility base 4.

In general, the utility base 4 is characterized by a “hot redundant” architecture protecting against two points of failure of all its vital functions (links to the ground, robotic functions, docking spaces) and mechanisms (e.g. electric power subsystem, attitude control subsystem), providing survivability of itself and of the carrying fleet against double failures.

The utility base 4 comprises means of active and passive surveillance of the surrounding space (ranging lasers, radar systems) and has active means (potentially reying on docked or otherwise available service vehicles 6) for avoiding collisions with other elements in open space (ablating laser). Given the replenishment capability of its resources through often replenishment missions and the high redundancy of is vital functions, the utility base 4 that is placed at the geostationary ring may in essence be the first space platform with indeterminable life span.

It is used to perform surveillance, protection, positioning, hosting, storing, reconfiguring, repairing, converting, assembling, and science missions.

Assuming the position of the utility base 4 at the Geostationary ring at mid day, a coordinate system passing from the geometric centre of its central segment is defined as follows. X axis has west to east direction, Y axis has Earth to Sun direction and the Z axis has South to North direction. For the X axis also the left-right notion is used where X increases to the left, for the Y axis the near-far notions are used where Y increases towards far, and for the Z axis Up an-Down notions are used where Z increases towards up direction. When relative reference of a segment of the utility base 4 other that the central one is made, in relation to the centre of the utility base 4, the terms IN-side and OUT-side are also used. In-side denotes the side close to the centre and out-side meaning the side of the segment at question which is opposite to the In-side at a direction departing from the centre.

The bus system of the utility base 4 mainly consists of a double redundant TT&C subsystem, a redundant attitude and orbit control subsystem (AOCS), a redundant electric power subsystem (EPS), a redundant data handling subsystem, and a redundant thermal control subsystem (TCS). All subsystems are characterized by hot redundancy. The utility base 4 receives power primarily from the solar panels 108 (preferably three or more) mounted onto booms connected to an axial truss through mechanisms having three degrees of freedom. The truss is characterized by passing from the geometric and momentum center of the main body 100 through the same axis as the robotic arm 114. The actuators of the solar panel mounting mechanisms of the primary and redundant solar panels 108, 110 are part of the AOCS.

The robotic arm 114 is designed to have five degrees of freedom (DOF) for the actual arm 120 and three degrees of freedom for its wrist element 122. The robotic arm 114 is dimensioned such that it can reach all upper, side and under areas of the utility base 4 that may need servicing.

The communication system or payload of the main body 100 also possesses a redundant near range mission communication system, preferably for ten-channel RF video reception equipment, a video switch system, and a redundant communication payload, for transmission to the ground of four uncompressed and twelve compressed digital video signals, generated by the various surveillance and teleoperation cameras. The redundancy of the mission communication system to the ground may provided by a specialized vehicle 10 docking at the far end of the equipment/storage bay 102.

The utility base 4 does not necessarily possess its own propulsion system, but fleet units (service vehicles 6/specialized vehicles 10) may be attached to the four sides and commanded appropriately when needed for orbit maintenance. Attitude stability of the utility base 4 is achieved, in short time, by use of the steering mechanisms of the solar panels 108,110. The utility base 4 is axi-symmetrically momentum stabilized.

The flexible storage module 106 mainly consists of a flexible, inflatable, lightweight balloon-like surface sheet, the size and shape of which may be modified by retreating means 124. In the embodiment shown, the retreating means 124 mainly are provided by contractable tapes which when contracted will diminish the volume of the interior of the module 106 while increasing its volume when allowed to expand. Examples for the module 106 in expanded and in contracted status are shown in FIGS. 6a and 6b, respectively. Accordingly, the flexible storage module 106 resembles a sack-shaped flexible storage bay which possesses a plurality of ring shaped, tape-measure type tape-fastener, externally secured to the sack by means of externally to the sack secured small elliptic fasteners. Said ring tape is driven by a reel-unreel mechanism with dual reels having independent motors. By reeling-in the tape the sack closes securing the free flying objects that are placed in this sack and by unreeling the tape the sacks opens to let the robotic arm 114 or other means collect the objects. Another tape fastened perpendicular to a securing ring on the external surface of the sack elongates or shortens the sack respectively, increasing or decreasing its volume.

The equipment/storage bay 102, the interior of which is schematically shown in FIG. 7, and which also may be referred to as a closed equipment storage bay (CESB), is mainly used for housing equipment and material sensitive to exposure to radiation, or temperature variations, or sun-rays, or small meteorites. It is where assembly, disassembly and testing takes place for small mechanical, electromechanical or electronic subsystems. The treatment of the material to be handled may or may not include packaging and un-packaging in protective boxes.

The west side of the equipment/storage bay 102 disposes a pressurization controlled pro-thalamus 130 with five outer doors 132 and a single internal door 134. The west door and inner door 134 are disposed one opposite to the other in a way to allow long objects equal to the long axis of the chamber to enter the bay in unpressurized conditions.

The equipment/storage bay 102 possesses conditioning means for effecting and controlling pressure, temperature and cleanliness by Nitrogen gas or other inert and nonvolatile gas. It possesses permanent camera viewpoints, equipment bay for manipulation of miniature mechanisms and electronic circuit boards and components.

The up-side and down-side in the thalamus 130 for further description are defined with respect to the position of the horizontal axis, up being the position where lighting sources and gas in-jets are mounted, down being the position where gas outlets are mounted. The gas jets are spread all along ceiling and gas outlets all along floor surface. The flow of gas from up to down creates a small pressure potential to the free flying objects in a way similar to gravity.

Manipulation of movable equipment within the equipment/storage bay 102 is performed by means of a number of three-arm small-sized robots 140 slidably and rotatably mounted on two horizontally secured axis 142. The long axis of the equipment/storage bay 102 defines the horizontal dimension. A third axis 144 with an H profile, the profile of which is shown in FIG. 8c, is disposed in between the above two mentioned axis and disposes two conductive surfaces 146 on its interior. Said conductive surfaces 146 are used by a the robots 140 to slide along while at the same time supplying them with electric power.

As shown in FIGS. 8a, 8b in greater detail, each robot 140 consists of a pair of two cooperative human-like manipulation arms 148, each having six degrees of freedom, and a third arm 150 of three degrees of freedom that is used for stability with a two finger gripper 152 designed to be engaged with the axis 144. Alternatively, for holding objects a three-finger gripper may be provided. The arms 148 of the robots 140 have ten finger grippers each. The robots 140 can be positioned in a face-to-face configuration for cooperative work. The human-like arms 148 of the robots 140 can be engaged to closed-chain kinematic configuration for manipulation of objects. This means the one arm 148 follows in tandem the movements of the other (driving) arm 148.

The robots 140 may be assisted by a plurality (minimum 2) of miniature (scale 1:3 of robots 140 or better) three arm robots 149 similar but without the sliding-rotation part of the robots 140. Mobility is provided by a sliding mechanism perpendicular to the first element of the stability arm. With small jumping movements, using the two or three arms, the robots 149 can always reach a horizontal axis, attach the sliding mechanism of the stability arm and slide along. These robots 149 either work from an axis or reach working place by a jump from the slide-on axis or are placed to workplaces by the robots 140. The robots 149 are secured, when in workplace, by means of using their stability arm (with 3 degrees of freedom). Alternatively, they can be held by the holding arm of a robot 140 for common manipulation of an object in parallel, assuming the object is secured in place by other means. The robots 149 when in workplace are connected to power/data/video-output interface and when in free float they use onboard power (batteries). Nevertheless, the floating time is limited and the respective battery size accordingly. The robots 149 dispose accelerometers and gyroscopic means for attitude control when in free floating conditions.

The equipment/storage bay 102 disposes its further elements mainly around at mid level a bench surface, filled with holes for letting air pass through and create a small virtual gravity effect, and a stiff edge for giving stability to the robots 140 when they grip on it. Disposes also a plurality of grips for securing objects in place for manipulation. It further disposes a table 154 for common, face to face manipulation with similar stiff edge, and a plurality of storage racks 156 for storing/affixing tools, accessories, and spares. The stiff edge and other places at the racks 156 possess connectors for providing the robots 149 with power/data/video interface. The distance of the storage racks 156 allows the robots 149 to use the stability arm to attach itself to a rack 156 while the other might be engaged to fetch/store activities. For moving from one rack 156 to another the robot 149 needs to stabilize itself by using the human like arms, gripping a horizontal shelf or a number of vertical bars, or a combination of a bar and a shelf, before disengaging the stability arm to move to another shelf.

The common table 154 is surrounded by tool & parts affix area mainly for mechanical works and a tool & parts affix area mainly for electrical & electronic works.

The docking/refueling rack 104, which in further detail is shown in FIG. 9, is designed to be semiautonomous and usable for all types of fleet vehicles 10, service vehicles 6, and the like. It is provided with standardized utility outlets 160 for power, data, video, fuel, oxidizer and pressurization gas. At least two of the docking positions defined by the outlets and their respective fixation means possess also relieve in-lets for emptying the supplies of a fleet unit. Said inlets for fuel, pressurization gas, and oxidizer are disposed symmetrically to the outlets, in respect to the docking unit centre. The docking/refueling rack 104 has a plurality of pairs of docking interfaces for the fuel, oxidizer and gas tanks 162 (min two for each species), disposed at the upper and if needed also lower sides of the same. Each fleet unit docking position has a pair of active securing mechanisms disposed symmetrically to the centre of same. The tank docking positions have each a three-point active securing mechanisms. The schematics of these locking mechanisms are shown in FIGS. 10a, 10b, which display the side surface 166 (FIG. 10a) and the upper surface 168 (FIG. 10b) of the rack 104 with the other parts (esp. tanks 162) removed.

All fleet unit docking positions dispose retroreflectors for aiding approach and docking. The centre of each fleet unit docking position is hollow to allow the grapple arrow pass the rack surface and secure the position by opening the arrowheads and retracting.

Distributed pairs of docking positions without fuelling outlets but with data and power outlets are disposed at all four sides of the utility base 4.

The docking/refueling rack 104 is semiautonomous in the sense that it possesses a limited power supply storage system, a thermal control subsystem and a data handling subsystem that is designed for supporting docking, fuelling operations and conditioning independently of the main body 100. The docking/refueling rack 104 can provide, through a data interface, to the main body 100 of the utility base 4 all locally available data.

A further position on the docking/refueling rack 104 is reserved for a specialized vehicle 10 which can activate its cameras when needed, to survey the docking/refueling rack 104 and the rest of the utility base 4. The video signal of the cameras can become available to the video switch of the main body either through a video interface or via RF transmission to the RF reception payload of the main body 100. The docking/refueling rack 104 also possesses a redundant pressure-up equipment for helium gas which is operated only when connected through the interface to the main body 100. This capability of autonomous operation allows for the disconnection of the docking/refueling rack 104 from the utility base 4 when deemed there is increased risk associated to performing hazardous operations such as refueling. The docking/refueling rack 104 in this case is removed by means of operating one or more fleet units and is returned back when hazardous operations have been completed.

The mechanical interface 170 that connects the dockin/refueling rack 104 to the main body 100 disposes also connectors for the realization of connecting the various interfaces of the docking/refueling rack 104 to the main body 100 (power, data, video).

Docking of other vehicles/objects is performed through customization of extension constructs. After a target spacecraft 2 or another floating object towed by fleet units is delivered to the robotic arm 114 for stabilization, stabilization grids are erected as required for securing the object in place and release the robotic arm 114 for other activities. These grids are constructed by means of a plurality of booms that are secured along the top of the equipment/storage bay 102, by means of fasteners.

Furthermore, the utility base 4 may be equipped with an open storage bay (OSB). Said bay is used to store equipment, tools, materials, products and spares that do not require protection or conditioning, packaged or un-packaged. It may consist of two symmetric racks, east and west, which are attached to the near side of the main body 100, through respective mechanical, electrical, data, and video interfaces. Both racks (for redundancy purposes) comprise interfaces for operating (command, data) an externally mounted detachable parabolic antenna each, for communication with the fleet. In the case the stabilization grid is deployed the redundant antenna is mounted onto the most western boom. They also both, for redundancy purposes, dispose interface for power control and video for driving a catch system as will be explained below. The two racks are stabilized by means of a bridge 172 connecting their near sides. Said bridge 172 disposes in its middle a docking station 118 for a fleet unit, preferably a service vehicle 6 or a specialized vehicle 10, which possesses cameras, and a shaft for mounting the catch system. The cameras of the service vehicle 6 or the specialized vehicle 10 can assist fetching storing operations of the robotic arm 114 and of the catch system. The down inner corners of the storage racks, the down near corner of the main body 100 and the down part of the rack connecting bridge 172 dispose fastening points, respectively.

The catch system 180, which may be placed in different positions at the utility base 4, is shown in FIG. 11. Designed as a tape based capture tool (TCT), it mainly consists of a double reel-unreel mechanism 182 mounted on a 3 degree of freedom mechanism (184), two conductive tapes (186) that extend in parallel, and an end piece 188. The end piece 188, which is shown in more detail in FIG. 12, is equipped with a camera, a number of light sources, a 3 degree of freedom gripping wrist 190 serving as a capturing mechanism. The catch system may be mounted onto a docking base sliding on a shaft attached centrally on the inside of the rack connecting bridge 172, in a way that the cameras of the fleet unit (service vehicle 6 or specialized vehicle 10) docked on the bridge 172 can supervise the activities of the same.

The catch system 180 is detachable from the docking base. Similar docking positions are available at the pressurized compartment of the equipment/storage bay 102 and on the far side of the open equipment bay. The robotic arm 114 can also capture and operate the catch system 180. The end piece 188 further possesses tension sensors for each tape, gyroscopic accelerometer 192, zero to four momentum wheels 194 for attitude control, RF means for transmission of the camera video signal, and a power conversion box 196. The power (alternating current) arrives to the end piece 188 by means of the two conductive tapes 186. It is converted to appropriate voltage ratings and distributed where needed. Control signals arrive to the end piece 188 by means of modulating the alternating current transported through the tapes 186. Video link is transmitted form the end piece 188 by means of an RF transmission. The RF signals are received by a central RF reception base.

Small and medium volume objects for storage may be placed into boxes and boxes are secured in a set of adjacent shelves of parallelogram shape of various sizes assembled out of aluminum or carbon fiber elements or other strong lightweight material. Said shelves may comprise a plurality of temporal adhesive tags at their bottom side that secure boxes when in place, even if a plurality of small boxes is stored into a large shelf. The fetching and storing of objects is performed by means of the robotic arm 114, the catch system 180, or other.

The upper side door 132 of the pro-thalamus 130 (FIG. 5) is reachable by the robotic arm 114 and two appropriately positioned catch systems 180. All 5 outer doors 132 have mating interfaces for extension modules. The pro-thalamus 130 houses a round rotating plate equipped with a catch system 180 in the one side of the table, which table can be raised, when an outer door 132 of the pro-thalamus 130 is open, above the upper surface of the equipment/storage bay 102. This way, an object that has been placed on the pro-thalamus table with the help of the catch system 180 can become available to the outside and vice-versa. The catch system 180 can also make available objects to the interior of the main thalamus of the equipment/storage bay 102 when inner door of pro-thalamus 130 is open.

In general, the fleet units of the servicing system 1, in particular the service vehicles 6, do not have redundancy or means for significantly reconfiguring themselves, as regards their hardware. Reconfiguration, repairing, assembling, upgrading is performed at the utility base 4 using special purpose facilities. In addition, the upgrading subsystem is used for conversion of captured foreign objects (CFO). Said CFOs that are of main interest for conversion are non-functional satellites, tanks from spent upper stages, and the like.

The upgrading subsystem comprises at least: an open equipment bay (OEB) and a protected, or closed equipment-storage bay 102 (CESB). Said OEB is mounted at the far side of the main body 100, through a mechanical electrical and data interface and the CESB is housed in a nitrogen gas pressurized chamber mounted at the west side of the main body 100.

Said Open Equipment bay “OEB” is used for mechanical or electrical works on the fleet, target spacecraft 2s, or CFO. Conversion operations, be between else processes for effecting access windows on tanks, pipe connecting/disconnecting, rack mounting, equipment and cabling network installation.

Said OEB possesses a plurality of (minimum two) of human size dual robotic arms (primary and redundant) for tool/manipulation with ten finger grips, and arm articulation similar to the human (six degrees of freedom). Said dual robotic arms are movable on top of the main body 100 and OEB by means of a mobile base that slides onto a T shaped rail path mounted on their surfaces. The rail path starts at the near edge of the upper surface of the main body 100, crosses the upper surface of the main body 100 with direction towards the OEB. It passes at a sufficient distance from the centre of the main body 100 where the robotic arm 114 is mounted. Said rail path then crosses the OEB in a parabolic shape and then passes on top of the CESB having a mounting point on it and continuing in a hemicyclic shape arriving to the upper side of the storage rack.

Each robotic mobile base is driven by four powered wheels mounted on axis parallel to the rail shaft and pressing against said T rail shaft. Six ball bearings for sliding along the rail head are provided as well as four short ones mounted just below and two wide ones above the T rail head, mounted in parallel to the said horizontal T rail head.

OEB also possesses a plurality of tools and benches for performing the said services similar to what is found in the Ground Segment Support equipment and particularly those that can be exposed to the open space environment with limited shielding.

The utility base 4 has a stock of accessories for repairing & upgrading the fleet and own subsystems.

These accessories between else include replacement modules for the hot redundant elements of the utility base 4, (EPS, AOCS, MCP, RF, TT&C) telecommunication modules for UHF and S band and data channel telecommunication modules for C, Ku and Ka band of various output power ratings. They further include attitude control sensors (sun, earth, star based), cameras of various aperture ratings, filters, lenses, endoscopes and telescopic probes, towing tethers tether/wire deployment/retracting add-on module as well as sets of retroreflectors, laser diodes, motors, ball bearings, lubricants and lubricating means. Adhesive materials, insulated wires, solar cell spares and fly wheel spares, valves and pipes, thrusters and any other accessory that may be foreseen, need assessment based on a statistical estimation of failure risks of the target spacecraft 2 components and subsystems.

Said repairing and upgrading tools comprising, between else, of hardware tools set, (lathe, aluminum soldering, etc), electrical tools set (wire connectors, soldering etc), electronic tools set (polymeters, palmographs etc.)

A plurality of tether equipped truss assists in the disassembly process by displacing disassembled elements away of the OEB core. Each time a disassembled element is attached to the tether the tether is promoted proportionally to the size of the attached element. To fetch a stored element from the tethered truss the tether is advanced or retracted accordingly.

The utility base 4 also is equipped with active and passive surveillance means.

These means are used for accurate positioning of objects in the surrounding space and for protection from space debris as well as for assisting cruise or automatic docking of the fleet units. The proximity radar provides a coarse but wide image of the surrounding space objects and the ranging laser a precise determination of distance and position of objects in the surrounding space. The ablating laser destroys small objects or alters the trajectory of larger objects to avoid collision with target spacecraft 2 or utility base 4 or fleet units. It also destroys or steers the particles that escape from the manufacturing processes to a desired collection point.

The utility base 4 requires numerous video and Telemetry links to be established for full operation. A gradual process is envisaged to provide the required bandwidth with use also of a resurrected satellite.

The specialized vehicle 10 may be designed to perform several functions of a so-called escort agent (EA). It basically has the same functional elements in its bus as a typical service vehicle 6 but reinforced in terms of EPS budget and size. It is mainly used for missions with FCO and non-cooperative target spacecraft 2, or with target spacecraft 2 where compatibility with its payload has not been achieved.

Its payload consists of two steerable high gain antennas, for establishing receiving link and retransmitting link to different directions, and cameras. It is designed to assist the docking and other services of a service vehicle 6 by establishing the required surveillance and teleoperation video links with a ground control unit 12 directly or through the utility base 4, or through a third spacecraft. It receives through RF video and TTC signals from a service vehicle 6 or directly from its own cameras and retransmits after amplification.

A type of escort agents with refueling capability is defined for refugee rescue missions or other high energy orbit missions.

The primary operational concept for the servicing system 1 is to reuse the service vehicles 6 and other elements of the system in many missions, servicing satellites that are far away in terms of delta velocity potential required to reach them and carry them or maintain their orbit or optimize their trajectory, in particular by using the target spacecraft 2 for relaying signals to ground control.

Nowadays, most of the satellites are operating in the C, Ku and Ka bands. Constructing communication means of very low power in a wide part of these bands to allow compatibility with a large population of satellites is not a problem. In addition to that, the utility base 4 comprises means for performing extensive reconfiguration and communication module exchanges so that the service vehicle 6 can become compatible with almost the totality of the current satellite population. Since in short distances of a few meters to hundred meters away from the target spacecraft 2, the service vehicle 6 will have to operate the said link, directionality of the antennas is not that important and that there are backwards electromagnetic wave lobes that can be exploited for this cause.

The advantage of the method is the provision of the needed bandwidth with extremely low powered means. In the case where the powerful communication means of the target spacecraft 2 are used as relay means, the means required in the ground for reception of the service vehicle 6 is as simple as a simple TV receiver in the case of TV satellites.

Alternatively as it is foreseen in the case where the target spacecraft 2 can not provide the required transmission means another specialized vehicle 10 will perform the task of establishing the link to the ground directly or through a relay, acting as relay satellite in the very vicinity. In this case it might also observe the service vehicle by its own means and provide alternative or the only view point of the service provision to the ground controllers.

The utility base 4, or a third satellite can serve as relay points, but these constitute less preferred options.

When the service vehicle 6 is in close proximity to the target spacecraft 2 even the telemetry/telecommand link can be performed through the target spacecraft 2. The method for receiving telecommands at the service vehicle 6 in this case is by listening to the telemetry of the target spacecraft 2 and select those packets that will be properly identified that are addressed to the service vehicle 6. This will further reduce the energy waste and increase the comfort of the target spacecraft 2 operators.

Apart from the cases where the service vehicle 6 will act alone or with the help of a service vehicle 6 a set or behaviors is designed to capitalize on the fact that a plurality of them will be available.

A method for reaching a signal from a remote place back to the utility base 4 or elsewhere can be performed by placing a plurality of service vehicle 6 in distances according to their respective telecommunications means and effect the transmission by means of relaying from one to the other the signal until it reaches the destination.

A service vehicle 6 also can carry other service vehicle 6 (towing pushing) docking side by side.

A set of service vehicles 6 can add on their thrust power and perform a relocation mission.

A set of service vehicles 6 can add their reception transmission means in a formation of a large phased antenna array by positioning themselves according to the desired source of signal or target and coordinated by means of a special Escort agent of the utility base 4 to operate on this mode.

Several functions may be automated. Most importantly, the docking operation to the utility base 4 and the docking operation to the Engine Module. Advantage of both is the reduced need for teleoperators and resources to establish the video and control link.

In the case of the docking to engine module or other service vehicle 6 or specialized vehicle 10 which is far apart from the utility base 4 the additional advantage is the autonomy achieved. It can be planned at any time. Low level of resources required as docking is performed with optimum fuel usage and provides high level of confidence to the owners of the target spacecraft 2.

A currently preferred embodiment of the service vehicle 6 is a canonical (rectangular, pentagonal, hexagonal) rod shaped structure covered with solar panels. In another embodiment a pair of solar panels shall be deployable and retractable. When the panels are retracted and secured on the service vehicle 6 surface the service vehicle 6 can be navigated as a spin axis stabilized spacecraft. The solar panels will be deployed mainly after docking to a target spacecraft 2 to extend beyond the shade of the satellite that is serviced. The service vehicle 6 will have the main thruster in its bottom side while at the top side will have the simple grabble mechanism to grabble the target satellite by the interior of the fuselage.

The one side of the service vehicle 6 will be capable of performing docking to the utility base 4 or to an Escort vehicle 10 for refueling. The docking and refueling mechanism will be positioned to lower half part of the service vehicle 6 so that the refueling can be possible even if the service vehicle 6 is attached to a target spacecraft 2.

The service vehicle 6 will be passive as regards the mechanism for the refueling docking but with adequate passive targeting aid (laser retro-reflectors) to ease proximity and semi or fully automated docking. The service vehicle 6 will benefit from the stability of the common docking place. In this way they will be able to switch most of their equipment (momentum wheels, communication payloads, thermal subsystem saving), reducing their wear and increasing their lifetime (form 100% up to 1000%). There will be economy of resources. Fuel consumption reduced to zero, power consumption will be reduced to 2%.

The proximity of the service vehicle 6s one to the other can reduce heat dissipation. Further economy. The proximity of the service vehicles 6 can provide inter-alia protection against debris.

The service vehicles 6 can benefit from a deep-storage mode where some elements could even be extracted for placement under special conditions for extending their lifetime. The battery can be stored separately form the service vehicle 6 in appropriate conditions. The fuels can be flushed out to avoid corrosion of tanks, pipe lines, valves and other elements form leaks. The tanks could be depressurized to reduce mechanical stress from pressure. The service vehicles 6 can benefit from service vehicle 6-to-Client interface reconfiguration available at the utility base 4. The service vehicle 6 will be receptive to interface configuration changes. It will be possible to change the Communications payload and the grabble mechanism to customize according to client characteristics. The service vehicle 6 can benefit from service vehicle 6 to ground interface reconfiguration service available at the utility base 4. The utility base 4 will have the capability to change the configuration characteristics of the service vehicle 6 Interface to the utility base 4. The communication payload may be adjusted depending on the required down link to be used through an Escort-service vehicle 6, through the utility base 4 or through the target spacecraft 2 or otherwise.

The service vehicle 6 can benefit from mission dependent reconfiguration. The optimum reusability and efficiency will depend on this capability of the utility base 4 to provide this type of reconfiguration. For each mission the fuel reserves will be adjusted, the communication payload will be reconfigured. Transceivers of appropriate strength will be installed and other characteristics will be adjusted (momentum, thruster position)

When a given spacecraft is close to another spacecraft it can capture the telemetry produced by the first said spacecraft by very simple means as the transmission takes place customarily with a unidirectional antenna and at power levels sufficient to reach earth.

The telemetry information is transmitted into standardized packets and usually consists of acknowledgments of commands, parameter values from various sources, memory dumps and simple echo messages. A number of these telemetry data packets and specifically these whose content can be forced to particular content by telecommands (like echo telemetry, or memory dumps of certain areas) can be selected to carry command data that are addressed to another spacecraft in the range of the telemetry of the first spacecraft.

This method invented can be used by any spacecraft that can listen-in to the telemetry of the first said spacecraft.

The method is proposed to be exploited by the plurality of apparatuses here invented and intent to offer services to target spacecraft 2.

This method, provides merit form the technical and economic point of view. The means used for the first satellite to perform the telecommand link are reused at no extra cost by a plurality of other satellites in a master-slave configuration.

Additional merit of the invention in the case where the method is applied to control plurality of servicing satellites is the assurance provided to the target spacecraft 2 owner that no dangerous commands may be sent to the plurality of the servicing vehicles. He will have full vissibility and control to the operations of the servicing vehicles.

The method is applied by the current invention to make economies in the telecommand reception means and power consumption and to reinforce the confidence to the target spacecraft 2 owners that they have full control of the process. Method of recovering telemetry information from a satellite whose telemetry means transmit at very low power output or buffering is required or encrypting the telemetry information is required.

It is desired in certain circumstances to listen from close distance to the telemetry information of the target spacecraft 2 either because the telemetry transmission means can not produce a high power signal, either for power constraint/preservation reasons or because of problems in the telemetry transmission means.

Additional reasons for listening in can be the need to store the telemetry for transmission at a later time. This is especially useful to low earth orbiting satellites that circulate earth and therefore are not all the time in the field of view of a ground station.

Still another reason is the possible need to encrypt the telemetry before transmission, need that became apparent after the design phase of the target spacecraft 2.

In all the above circumstances it will be beneficial to provide a means of retransmitting the telemetry of a target spacecraft 2 at another frequency and at higher power or with a delay or in encrypted mode or in any combination of the above.

The proposed method of invention is the delivery of a service vehicle 6 equipped with the appropriate listen-in, possible buffering, possible encryption and retransmission means preferably to an up-link channel or directly to the ground.

The choice of way of establishing the feed link depends on the availability of the said up-link. If the direct link is the choice appropriate modification of the standard service vehicle 6 shall be performed before mission starts at the utility base 4. The appropriate modifications shall include above standard power generation means, power conditioning means and telemetry retransmission means.

An uncontrollable target spacecraft 2 that tumbles is very difficult and dangerous to capture because it may damage the spacecraft that attempts approach for the capture.

A new method is proposed for stabilizing a tumbling spacecraft as follows:

A pair or service vehicles 6 is equipped with an add-on dual wire deployment/retracting system (WDRS), secured in their lower part of one of their sides. Each of the said WDRSs are equipped with a camera or the pair of service vehicle 6 is escorted by an Escort service vehicle 6 with camera and telecommunication means. The length of the wire (rolled in the said WDRS) shall be several hundred meters in order to allow operation of the escort service vehicle 6 without risk of contamination against the target spacecraft 2. The middle of the wire is equipped with a multi anchor apparatus or a net or simply a loop, whatever the case defines as more appropriate that would capture the SC if comes to its path.

Formation flying of the pair of the service vehicles 6 in proper angle shall enable the tumbling target spacecraft 2 to be captured. Depending on the moment of inertia of the target spacecraft 2, the service vehicles 6 shall perform well timed, directed and weighted thrusts against the force the wire will effect as it folds around the tumbling spacecraft. A third service vehicle 6 shall observe closely the whole operation. It shall ease the targeting of the wire capture and determine the risk of damage to the spacecraft after the capture is achieved to direct properly the tumbling attenuation operation.

In some cases, the transportation of a target spacecraft 2 to higher latitudes, if it has been stacked below the required altitude, or need to go to far longitudes, or need to implement a high inclination correction or for other reasons, requires high acceleration-deceleration maneuvers.

The said transportation requires stability of the solar panels to avoid deformation or damaging them, and to avoid destabilizing libration of the said solar panels during acceleration-deceleration phases of the said transportation mission.

A simple, low material requiring method, is envisaged in order to secure the solar panels from deformation and libration caused by said acceleration/decelerations of the said transportation mission

A plurality of service vehicles 6 (minimum one, preferably two, more preferably three, most preferably five) equipped each with a wire deployment & retracting system in one side and a sidewise gripe on their front side and a plurality (zero or more) of Engine Modules is deployed. The said Engine modules secure themselves with the help of the said plurality of service vehicle 6 to the fuselages of the said target spacecraft 2. Then, each of the service vehicle 6 in turn secures at the EMs the tip of a wire protruding from the said wire deployment/retracting system. The said service vehicle 6 capture the solar arrays from their tips at the two ends in a manner that the axis of the body of the said service vehicle 6 is perpendicular to the panel surface. After securing the grips the wire retracting systems retract the wires forcing the tips to stability and pressing the lower part of the Engine Module/service vehicle 6 against the said target spacecraft 2. In this configuration the service vehicle 6 that are attached to the panel tips can perform thrusts, of which thrusts the vertical component vector of force is effected mainly to the base of the Engine Module and partly to the stiffened solar array panels. Advantageously, the distribution of the force in the three extreme points of the transported body gives excellent moment of inertia and steering capabilities.

Steering of the panels can add to the maneuverability of the system.

The thrust history of all thrusters in the system will be archived together with loads (wet or dry), attitude and gyroscopic information, internal acceleration measurements and acceleration measurements as externally observed by laser ranging from the utility base 4. The totality of this information will be analyzed after every mission and new calibration parameters will be made available. The same parameters minus the ranging information (when away from the utility base 4) will be monitored real time by the thruster owning object for updating the relative efficiency thruster table.

For the mass calculation the following method applies when measurement takes place away from the utility base 4. A service vehicle 6 with recently calibrated thrusters attaches to the target spacecraft 2. The solar panels of target spacecraft 2 are secured in the most stable way. A plurality of EA with cameras and ranging lasers position themselves in the space in front of the target spacecraft 2 a little above and a little below its expected trajectory at a distance appropriate for the laser means. They point the laser beams towards the target spacecraft 2 and body and they take measurements during a smooth gradual acceleration phase until a few seconds after stopping acceleration. The acceleration shall be smooth and gradual in order to minimize the sloshing of the dry mass.

The analysis of thrusts data, ranging data, visual data, and simulation analysis on ground can give accurate estimation of the total mass and wet mass specifically.

The deployment of the servicing system 1 is proposed to start with the launch of a single service vehicle 6 that will make use of the target spacecraft 2 as a relay point therefore not needing neither escort service vehicle 6 for the HBTL nor utility base 4. It may be followed by one or more service vehicle 6 and/or by an escort service vehicle 6 with refueling capabilities. The refueling escort-service vehicle 6 will provide the required fuel reserves for the current and part of the upcoming fleet. A possible further refueling escort-service vehicle 6 may precede the arrival of the utility base 4.

Advantages of this deployment plan is the low initial cost and the high final functionality.

Three deployment areas are foreseen in the beginning
The Geostationary ring
The Low earth orbiting satellites
The Medium Earth orbits

The invention is presented to start providing service in the geostationary ring but the similar apply for the lower to earth orbits and to further missions around other celestial objects or to trajectories between celestial objects.

This split of functionality between utility base 4, service vehicle 6, EM and EA provides for low mass, low cost, high fuel/dry mass ratio, high maneuverability, long range and operating duration in the service vehicle 6, EA and EM part. On the other had the utility base 4 gives to the system high reusability, maintainability, multiple uses, elimination of waste. The system in total provides for efficient, reliable and low cost service operations.

Main advantage of this architecture is that the service vehicle 6 results in an extremely low dry mass, low cost, agile spacecraft that can service target spacecraft 2 which require large delta velocity potential. Yet main advantage of this element of design is that a dual arm robotic facility is also made available in the context of the system (through the utility base 4 component) allowing for extensive servicing operations.

A particular advantage of this configuration is that the service vehicle 6 is released by the highly demanding subsystem budgets (performance characteristics), required for a link with earth, which are required only for a small fraction of the lifetime of the service vehicle 6 while in the rest of the life time represent dead mass (large overhead in maneuvers). Placing this functional requirement to another element of the system that does not perform demanding maneuvers (to the utility base 4) it gives high flexibility and low construction and operational costs at the service vehicle 6 part. This fundamental characteristic of the design of the service vehicle 6 is new, unique and useful.

The service vehicle 6 does not need to have redundancy of most of its sub-systems (power, solar, propulsion). Its only safety characteristic will be that it will have fail-safe mechanism of its grabble. The service vehicle 6 will capitalize on the presence of utility base 4 in the relative proximity and also of the similar service vehicle 6 that will be able to perform a rescue operation with target the failed service vehicle 6.

Special Escort-service vehicle 6 will have capability to refuel other service vehicles 6.

Advantages are: A service vehicle 6 can perform of a heavy mission (high delta velocity) without having to return to the Utility base for refueling and performing again the rendezvous with the serving spacecraft (mostly manual and difficult task). Instead it can remain attached to its mission and wait for successive installments of fuel by a refueling service vehicle 6 (depending on availability). In this way the required wet mass at the beginning of its mission can be very limited facilitating the rendezvous and docking as well as reducing the cost of orbit maintenance. In the occasion the mission finally required replenishment of the fuel this is achieved by the special Escort-service vehicle 6.

If a service vehicle 6 runs out of fuel the Escort-service vehicle 6 can replenish and then either separate or perform flight attached one to the other reducing the risk in case of failure of one of the two. The special-service vehicle 6 in the beginning of the deployment of the system may substitute the utility base 4.

The service vehicle 6 will take advantage of the capabilities of the utility base 4 to perform reconfiguration operations. It will be able to change communication payload and grabble characteristics in order to fit for service for a variety of potential target spacecraft 2.

The service vehicle 6 shall be able to enter an idle storage mode when docked on the utility base 4 or to another service vehicle 6. This will conserve the wear of most subsystems even the structure (by thermal cycles) and reduce the consumption of energy. This will become possible by the presence f the utility base 4 or an Escort-service vehicle 6.

A simplified version of the service vehicle 6 is the Engine Module that does not have cameras and the like for performing a navigation and docking. Is put in place on an target spacecraft 2 with the help of a service vehicle 6 or EA and remains there to perform station keeping and inclination maneuvers until it will require fuel replenishment. In this case, a service vehicle 6 with capability of automatic docking on the Engine Module will dock and provide fuel for another term of the mission.

### REFERENCE NUMERALS

1 servicing element
2 target spacecraft (Utility Agent, UA)
4 utility base
6 service vehicle
8 engine module
10 specialized vehicle
12 control module
14, 16 arrows
20 main body
22 propulsion system
24 docking system
25 exhaust system
26 cameras
28 built-in communication system
30 control system
32 dashed line
34 receiver
36 emitter
38 arrow
40 hollow axle
42 action axle
44 fail-safe mechanism
46 double arrow opening tip
48 surface
50 nozzle ring
52 exhaust channel
54 combustion chamber
60 communication module
62 multiplexer
64 modulator
66 transmitter
68 controller module
70 encoder
72 camera
74 proximity sensor
76 arrow
78 control module
80 receiver
82 arrow
84 demodulator
86 docking subsystem
88 branch line
90 retroreflectors
92 refueling module
100 main body
102 equipment/storage bay
104 delivery/refueling rack
106 storage module
108 primary solar panels
110 secondary solar panels
112 support grid
114 robotic arm
116 reflectors
118 docking station
120 actual arm
122 wrist element
130 pressurization controlled prothalamus
132 outer doors
134 internal doors
140 three-arm small-sized robots
142 horizontally secured axis
144 axis
146 conductive surfaces
148 human-like manipulation arms
150 arm
152 two finger gripper
154 table
156 storage racks
160 utility outlets
162 tanks
166 side surface
168 upper surface
170 mechanical interface
172 bridge
180 catch system
182 double reel-unreel mechanism
184 freedom mechanism
186 conductive tapes
188 end piece
190 gripping wrist
192 gyroscopic acceleraometer
194 momentum wheels
196 power conversion box

1-16. (canceled)

17. A service vehicle for performing an in-space operation on a selected target spacecraft, comprising:
a communication module having at least one of a transmission and a receiving characteristic configurable in order to meet at least one of a transmission and a receiving parameter of the selected targeted spacecraft.

18. The service vehicle as recited in claim 17, wherein the communication module includes a transmitter.

19. The service vehicle as recited in claim 17, wherein the communication module includes a configurable receiver.

20. The service vehicle as recited in claim 19, wherein the receiver has a wording frequency that is adjustable in so as to enable to communication with a telemetry channel of the selected target spacecraft.

21. The service vehicle as recited in claim 20, further comprising a control module configured to provide a setpoint for an output power of the communication module.

22. The service vehicle as recited in claim 21, further comprising a position sensor connected to an input portion of the control module, the first postion sensor delivering a set of data indicative of a current position of the service vehicle.

23. The service vehicle as recited in claim 22, further comprising a second position sensor connected to the input portion of the control module, the second position sensor delivering a set of data indicative of a current position of the target spacecraft.

24. The service vehicle as recited in claim 21, further comprising an orientation sensor connected to the intput portion of the control module, the orientation sensor delivering a set of data indicative of a current orientation of the target spacecraft relative to the service vehicle.

25. The service vehicle as recited in claim 17, further comprising a docking system having a hollow first axle and a second axle moveably disposed inside the first axle, the second axle carrying an activateable arrow tip.

26. The service vehicle as recited in claim 17, further comprising an identification device configured to identifying said target spacecraft.

27. A servicing system for providing in-space service operations to a selected target spacecraft, comprising:
a service vehicle that includes a communication module having at least one of a transmission and a receiving characteristic configurable in order to meet at least one of a transmission and a receiving parameter of the selected targeted spacecraft;
a ground control module for delivering operational commands to the service vehicle.

28. The servicing system as recited in claim 27, wherein the ground control module is configured to receive data from the service vehicle using the target spacecraft as a relay station for signals emitted from the service vehicle.

29. The servicing system as recited in claim 27, further comprising an orbit-based utility base for said service vehicle.

30. The servicing system as recited in claim 27, further comprising a relay module for forwarding transmitted signals to the service vehicle.

31. The servicing system as recited in claim 27, wherein further comprising an engine module attachable to at least one of a service agent, the service vehicle, and the target spacecraft.

32. A method for in-space servicing of a selected target space-craft, the method comprising:
performing an in-space operation on the target spacecraft using a service vehicle having a communication module that includes at least one of a transmission and a receiving characteristic configurable in order to meet at least one of a transmission and a receiving parameter of the selected targeted spacecraft;
and relaying command signals to the service vehicle using a telemetry channel disposed between a ground control module and the target spacecraft.
